(19) United States
(12) Patent Application Publication
(10) Pub. No.: US 2023/0005053 A1
(43) Pub. Date: Jan. 5, 2023

(54) Open Bidding System For Real Estate Transactions With An Escrow

(71) Applicant: Aisha Majeed, Staten Island, NY (US)

(72) Inventor: Aisha Majeed, Staten Island, NY (US)

(73) Assignee: Estate Here, Inc., Staten Island, NY (US)

(21) Appl. No.: 17/157,793

(22) Filed: Jan. 25, 2021

(51) Int. Cl. G06Q 30/08; G06Q 50/16; G06Q 30/02

(52) U.S. Cl. CPC G06Q 30/08; G06Q 50/163; G06Q 30/0213

(57) ABSTRACT

A computer-implemented open bidding system for real estate transactions is disclosed. The system comprises of agent or owner entities, an escrow of incentives associated with property entities, property entities, and buyer entities, as performed in the respective apparatus. The system is controlled by collecting information related to property entities from agents or owners in the open bidding system, storing the information in a database, determining incentives for the property based upon the information stored in an escrow database by an agent or owner, and availing the incentive to a buyer upon completion of a purchase transaction. On the whole, the system enables a method of listing properties in an open bidding system and a method of purchasing properties an open bidding system.

### FIELD OF INVENTION

In general, the present invention relates to property asset management and, more particularly, to an open listing system for real estate for real estate transactions.

### BACKGROUND OF THE INVENTION

Under the current regime of real estate platforms that work with brokers, the requirement is that the broker receive a fee/commission for closing a deal. Once the fee is determined the seller is ‘stuck’ in a exclusive listing contract which can not be changed until the contract expires between seller and real estate broker. During this exclusive listing agreement, a real estate agent has the monopoly at his discretion to who to give access to show this property too and to not show this property. Additionally, even if this fee is initially reduced there is no additional incentive to the buyer, renter, seller and even other agents.

In the open listing platform, interested buyers compete for the ownership of assets, while open brokers compete to close deals with buyers on behalf of the sellers without exclusive contracts. Usually, the seller will set the price of the asset, which serve as the basis for the negotiation process. The interested parties bid for the asset, and the listing continues until the seller or a broker closes a deal with a buyer. To promote the sale of their property, the seller may provide an incentive to open brokers or to buyers. Due to its open nature, the broker fee/commission can be changed at will, the seller doesn't have to sign an exclusive listing agreement and can give broker/agent the commission/fee at what ever amount seller wants who brings a qualified buyer or renter at closing table. Moreover, instead of reducing the broker fee/commission the seller has the option to apportion part of the funds towards a credit for appliances or other home improvement items at the buyers discretion as an incentive to encourage purchase. Such incentives are implemented via an escrow to promote trust.

As part of process, potential buyers are allowed a preview to check the listed properties and examine their condition without restrictions imposed by any broker. Once potential buyers are done viewing all the items and are interested in placing their bids, they may register to participate in the process. The registration process requires the buyer's details like phone number, address, and identification such as a passport or driver's license number. Each registered potential buyer has a unique identifier that is used to identify the participant.

The seller gives a brief description of the asset for sale and starts the listing with a price that he/she considers a reasonable price. In an open listing platform, the bulk of the process is carried out online. An online listing system is different from listing for a home in person through a trustee's sale or a sheriff's sale. For starters, listing is conducted via the web.

Generally, an escrow is a financial arrangement where a third party holds and regulates payment of the funds required for two parties involved in a given transaction. It helps make transactions more secure by keeping the payment in a secure escrow account which is only released when all of the terms of an agreement are met as overseen by the escrow company.

Escrows are very useful in the case of a transaction where a large amount money is involved and a certain number of obligations need to be fulfilled before a payment is released like in the case of a website being built where the buyer might want confirmation of the quality of work being done before making a full payment, and the seller doesn't want to extend a massive amount of work without any assurance that he or she will receive payment. While traditional escrow service is quite difficult and must be obtained through banks and lawyers, there are online escrow services at affordable rates. While the payment is ‘In Escrow’ the transaction can be safely carried out without risk of losing money or merchandise due to fraud. This eliminates all legal jargon and allows for secure transactions and confident buyers and sellers.

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

A computer-implemented open listing system for real estate transactions is disclosed. The system comprises of agent or owner entities, brokers, an escrow of incentives associated with property entities, property entities, and buyer entities, as performed in the respective apparatus. The system is controlled by collecting information related to property entities from agents or owners in the open listing system, storing the information in a database, determining incentives for the property based upon the information stored in an escrow database by an agent or owner, and availing the incentive to a buyer or open broker upon completion of a purchase transaction. On the whole, the system enables a method of open listing system without exclusive contracts with brokers and a method of purchasing properties.

### BRIEF DESCRIPTION OF THE FIGURES

FIG. 1 of the diagrams illustrates a computer implemented open listing system comprising of portable computing devices, a network, a database and a server or servers

FIG. 2 of the diagrams is an illustration of an agent entity (or owner) and its profile, and how it relates to property entities and the escrow of incentives

FIG. 3 of the diagrams is an illustration of a property entity with its associated details, and how it relates to an agent or owner and the escrow of incentives

FIG. 4 of the diagrams is an illustration of a buyer entity with its profile and how it relates to a property, an agent or owner and the escrow of incentives

FIG. 5 of the diagrams is an illustration of an escrow of the current invention and its relationship with the agent or owner, open brokers, property and buyer

FIG. 6 of the diagrams illustrates the method of listing a property in a computer-implemented open listing system

FIG. 7 of the diagrams illustrates the method of purchasing a property in a computer-implemented open listing system.

FIG. 8 of the diagrams teaches of a method of creating an agent/home owner and listing a property with an associated incentive in a computer-implemented open listing system.

### DETAILED DESCRIPTION OF THE INVENTION

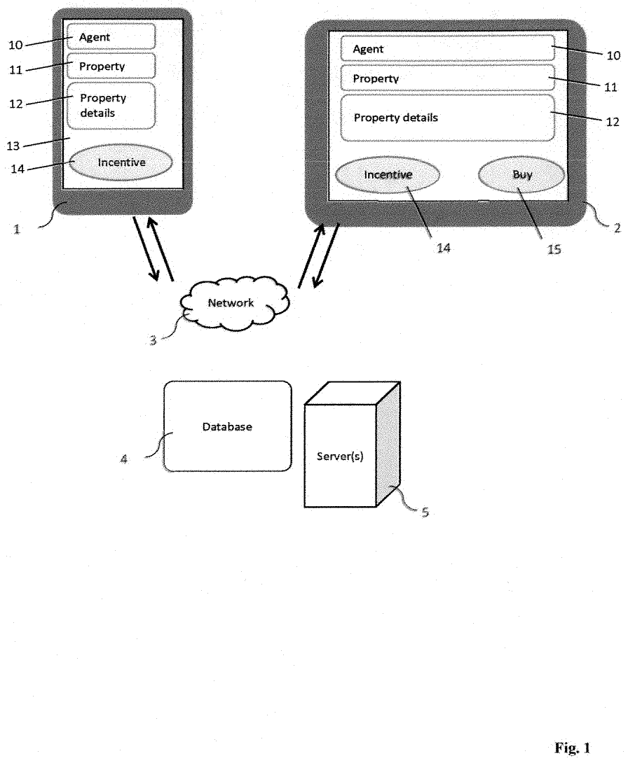

In the first embodiment according to FIG. 1 is a computer-implemented open listing system comprised of portable computing devices 1 and 2, a network 3, a database 4 and a server 5. On a first portable computing device is configured a computer program product with a graphical user interface 13, such a product being capable of generating an agent or owner entity 10, a property entity 11, the property details 12 such as price, location, images or any such information that would be of interest to a buyer, and an incentive 14 for purchasing the property including but not limited to a credit facility, purchase of certain items or even reduction of purchase price among others. The objects generated by the computer program product are transmitted via a network 3 to a database 4, in a server 5. On the other hand, a second portable computing device 2 is configured with a computer program product capable of receiving respective entities in a remote database through a network and displaying on the graphical user interface the agent or owner entity 10 of a certain property entity 11, the property details 12 such as price, location, images or any such information that would be of interest to a buyer, an incentive 14 for purchasing the property including but not limited to a credit facility, purchase of certain items or even reduction of purchase price among others, and a buy function 15. The incentive 14 is an incentive associated with a property as submitted as security such as to an escrow by an agent or owner of the respective property. Generally, each portable computing device has a configurable memory, on which a computer program can be configured, a graphical user interface, a processor that executes memory instructions and a network interface.

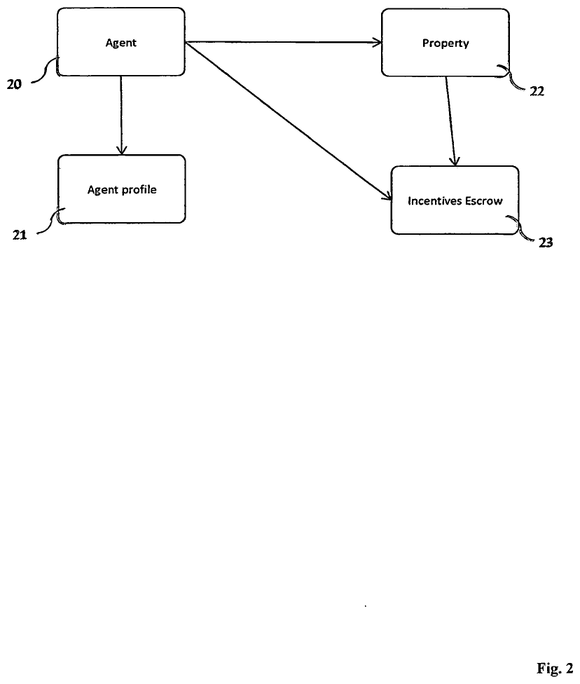

In the second embodiment according to FIG. 2 of the diagrams is an illustration of an agent entity 20, which for the purposes of this disclosure may alternatively be known as the owner, and its profile 21, and how it relates to property entities 22 and the security such as escrow of incentives 23. In accordance to the current invention, an agent is an entity in a database of a computer-implemented open listing system as shown in FIG. 1. In the current context, an agent 20 is any such entity in the database 4 identifiable as owning a property such as 22, has a profile 21, and creates incentives for buyers who purchases a property or for open brokers that help close a deal in a security such as an escrow 23. In the current invention, the security such as the escrow is out of control of the seller but it serves the function of ensuring that the seller is contractually obliged to fulfill the incentive after the sale. One such incentive is a commission to an open broker who is not contractually bound to the seller, but who nonetheless can participate in the sale process without the need to trust the buyer since the escrow ensures they can access their incentive after closing the deal.

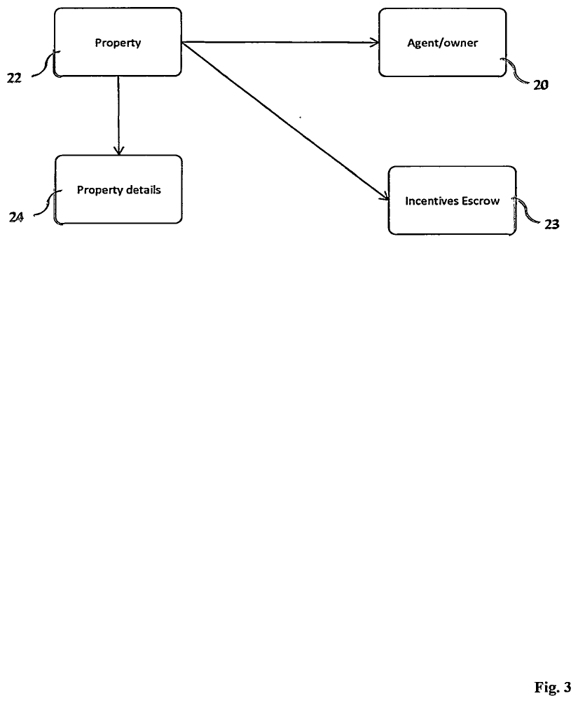

FIG. 3 of the diagrams is yet another embodiment according to the current invention, which illustrates a property entity 22 with its associated details 24, and how it relates to an agent or owner 20 and the escrow of incentives 23. The property entity is also stored in the database 4, in a storage device of the server 5, wherein such a property has an associated incentive in a security such as an escrow 23, such an incentive being one generated by the respective agent 20 using a portable computing device configured with the respective computer program product. Further, each property has associated details 24, which may include the price, location, images or any such information that would be of interest to a buyer such as opening bid amount.

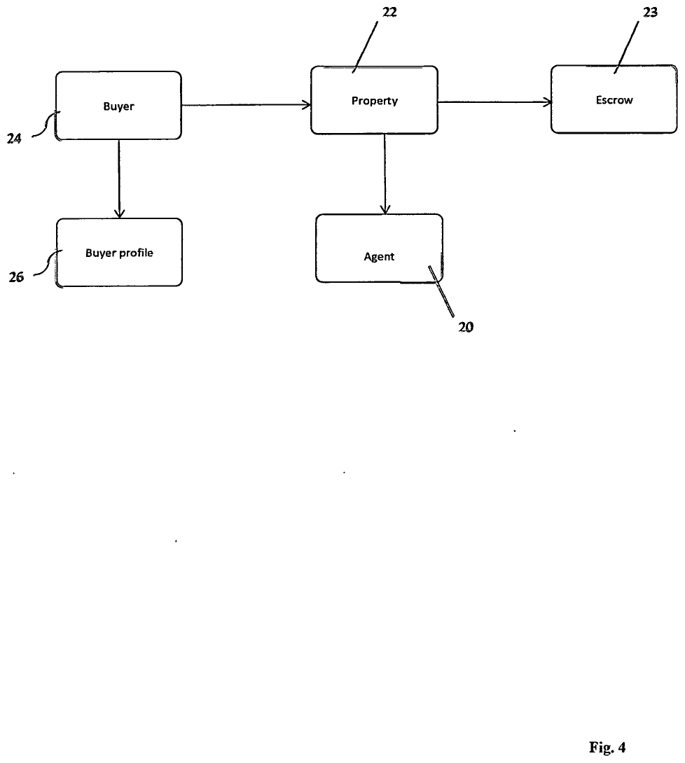

In another embodiment according to FIG. 4 of the diagrams is an illustration of a buyer entity 24 with its profile 26 and how it relates to a property 22, an agent or owner 20 and the escrow of incentives 23. The buyer entity is stored in the database 4, in a storage device of the server 5, wherein such a buyer has an associated buyer profile 26, such a profile may include the buyer's details like phone number, address, and identification such as a passport or driver's license number. In the current context, a property 22 is any such property that a buyer may purchase or planning to purchase. The property has an agent or owner 20, and an incentive associated with purchasing it in a security such as an escrow 23. When a buyer submits a bid towards purchasing a property, such a bid becomes available to the agent through the relationship between a property entity and the agent. Furthermore, upon purchasing a property, the buyer may access the incentive associated with the respective property as provided by the agent from the security such as an escrow 23. The incentive is also displayed on a configured portable computing device of the respective buyer.

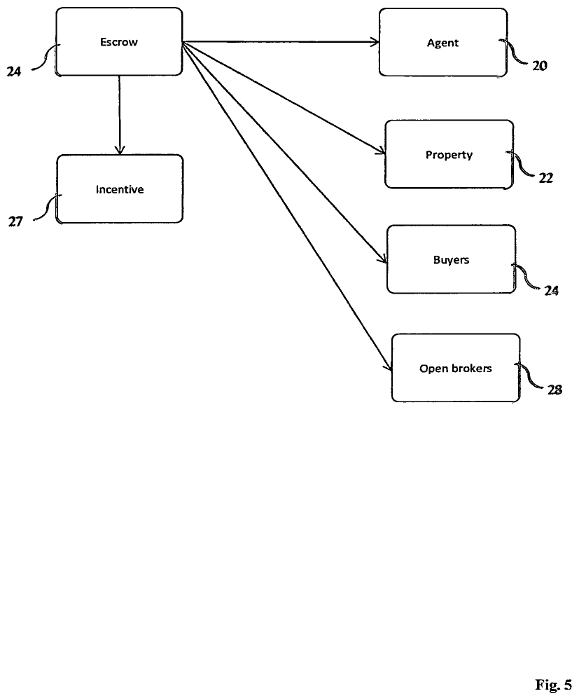

Further still, in an embodiment according to FIG. 5 of the diagrams is an illustration of an escrow 24 of the current invention and its relationship with the agent or owner, property and buyer. In its essence, an escrow is any such financial arrangement where a third party holds and regulates payment of the funds required for two parties involved in a given transaction. It helps make transactions more secure by keeping the payment in a secure escrow account which is only released when all of the terms of an agreement are met as overseen by the security such as an escrow company. In the current context, the escrow securely holds incentives provided by sellers to buyers of property securely until a transaction is completed. An escrow contains an incentive 27, such an incentive being the object of a property 22 as submitted by an agent 20. The buyers 24 of a property with an incentive submitted in an escrow are entitled to such incentives without relying on the sellers that provided the incentive. On the other hand, the open brokers 24 in the context of the current invention are free agents that may opt to sell any property listed for an incentive such as a commission, such an incentive being securely held in the security such as an escrow.

In the case of a transaction where a large amount money is involved and a certain number of obligations need to be fulfilled before a payment is released like in the case of purchase of properties where the buyer might want confirmation of the quality of work being done before making a full payment, and the seller doesn't want to extend a massive amount of work without any assurance that he or she will receive payment, an escrow is very useful. While traditional securities such as an escrow service is quite difficult and must be obtained through banks and lawyers, there are online services at affordable rates. While the payment is ‘In Security’ the transaction can be safely carried out without risk of losing money or merchandise due to fraud. This eliminates all legal jargon and allows for secure transactions and confident buyers and sellers.

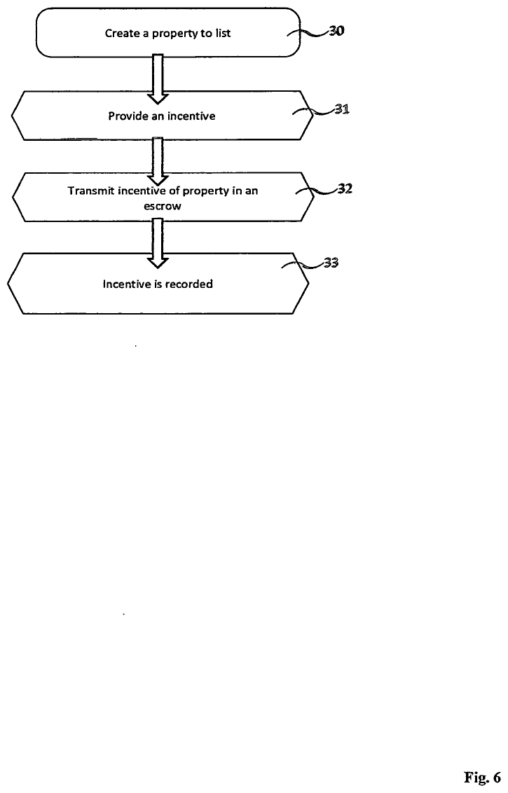

FIG. 6 of the diagrams teaches of a method of listing a property in a computer-implemented open listing system. On the figure is a process 30, of creating a property to list. The process 30 is performed on a portable computing device configured with a respective computer program product, and the property stored in the database in a remote network. The process 31 entails creating an incentive associated with the purchase of a property. Subsequently, the incentive is transmitted to a security such as an escrow service 32 via a network, wherein such an incentive is recorded in the process 33. The incentive is applied to either open brokers and buyers in the open listing system or both.

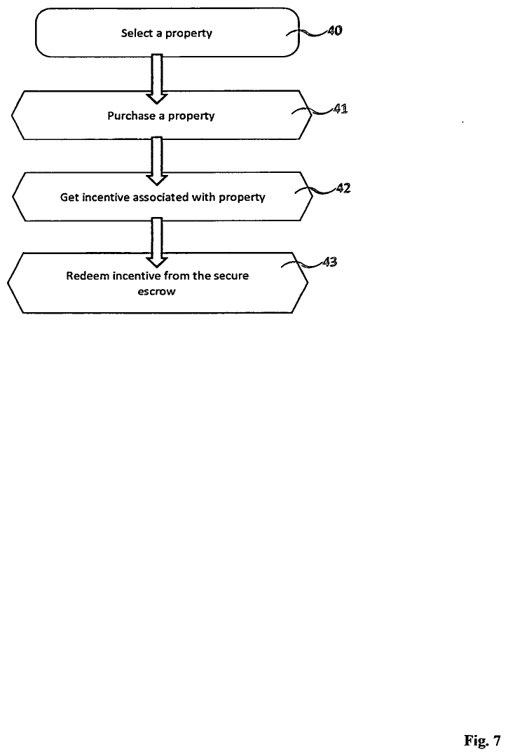

In an embodiment according to FIG. 7 of the diagrams, it is illustrated a method of purchasing a property in a computer-implemented open listing system. The method performed using a portable computing device comprises of the process of selecting a property for purchase 40, the process of purchasing the property 41, the process of getting an incentive associated with property 42, and a process redeeming the incentive from the escrow 43. In the context of the current invention, the process of redeeming the incentive from the escrow 43 entails acquiring the respective benefit provided by the seller from the escrow service. Such a benefit may be to either a buyer or an open broker who closed the sale on behalf of the seller. The purchase of property may be performed such as using an online payment service, electronic funds transfer or any such method of transacting, provided that the seller has access to such a transaction and can validate it as an authentic transaction.

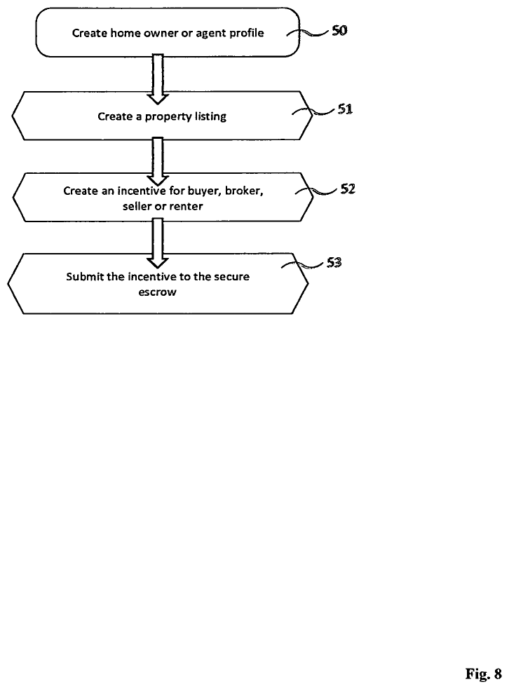

In a final embodiment according to FIG. 8 of the diagrams, it teaches of a method of creating an agent/home owner and listing a property with an associated incentive in a computer-implemented open listing system. On the figure is a process 50, of creating a home owner or agent profile in the database. The method may entail collecting personally identifiable information such as email addresses, telephone numbers o any such information that allows them to gain access to the computer-implemented system in an identifiable manner. The process 51 is performed on a portable computing device configured with a respective computer program product, wherein a property listing associated with a home owner or agent profile is stored in the database in a remote network. The process 52 entails creating an incentive associated with a property at the close of a deal, either for a renter, buyer, open brokers or agents of a home owner. Subsequently, the incentive is transmitted to security such as an escrow service via a network, wherein such an incentive is recorded in the process 53.

What is claimed is:

1. A computer-implemented open listing system for real estate transactions that comprises of:
agent or owner entities;
a secured incentive associated with property entities;
open brokers;
property entities, and;
buyer entities.

2. The open listing system of claim 1, wherein a security such as an escrow of incentives comprises of any such value gained from the purchase of a property by a buyer or an incentive gained by an open broker as provided by a seller from the sale of a property.

3. A method of listing properties in an open listing system that comprises of the steps of:
creating a property entity to list;
creating an incentive associated with the property entity;
transmitting the incentive to a security such as an escrow, and;
recording the incentive in the security such as an escrow.

4. The method of claim 3, wherein purchasing properties in an open listing system comprises of the steps of:
selecting a property for purchase;
purchasing the property;
getting an incentive associated with property, and;
redeeming the incentive from the security such as an escrow.

5. The method of claim 3, wherein selling of properties in an open listing system comprises of the steps of:
selecting a property for sale;
securing a buyer of the property;
getting an incentive associated with property, and;
redeeming the incentive from the security such as an escrow.

6. The open listing system of claim 1, further comprising of:
a portable computing device memory configured with a computer program product capable of creating an agent, a property entity, property entity details and incentives, and transmitting them a database in a network;
a network;
a server, and;
a security such as an escrow.
